(19) United States
(12) Patent Application Publication
(10) Pub. No.: US 2010/0057517 A1
(43) Pub. Date: Mar. 4, 2010

(54) Eco-systemic business model for a music entertainment company and the music industry

(75) Inventors: Fred Jerkins, JR., Galloway, NJ (US); Ernest Manigo, JR., Chestnut Ridge, NY (US)

Correspondence Address: Fred Jerkins, Jr.;Ernest Manigo, Jr., 251 Aschwind Court, Galloway, NJ, 08205, US

(73) Assignee: Opus One Corp., Orange, CA (US)

(21) Appl. No.: 12/584,913

(22) Filed: Sep. 15, 2009

(51) Int. Cl. G06Q 10/00; G06Q 30/00

(52) U.S. Cl. 705/8; 705/30; 705/1.1

(57) ABSTRACT

An eco-systemic business model for a Music Entertainment Company that will optimize the use of, and, exploit new method and system for generating, processing and allocating revenues earned in the Music Industry, optimize the use of, and, exploit new Mechanical Royalty Rate Formula and new Mechanical Royalty Rate (that can be Standardized within the Music Industry), and finally optimize the exploitation of entertainment assets such as (but not limited to) Record Artists and Music Catalogues, by implementing a new “Living 360° Music Entertainment Company” Business Model, which utilize the integration of various basic and transferable management and marketing strategies, business tools and business resources. Further, The “Living 360° Music Entertainment Company will exploit assets and products such as (but not limited to) Recording Artists, which will be developed, managed, marketed, place on tour (a tour produced by The “Living 360° Music Entertainment Company), exploited for merchandising opportunities, cross-marketing opportunities and product placements with advertising media and corporate sponsorships, and, exploited to selling albums/single records; all to be interrelated within one company and/or one network of associated and/or affiliated companies for the purpose of earning profit from all areas of the music industry, “across the board”.

### CROSS REFERENCE TO RELATED APPLICATION(S)

| Application Number | Filing date | Patent Number | Issue Date |
|---|---|---|---|
| 11/359,816 | Feb. 22, 2006 | 7,162,433 | Jan. 9, 2007 |

Related U.S. Patent Documents to application Ser. No. 11/359,816

| Patent Number | Issue Date | Inventor |
|---|---|---|
| 5,772,446 | June 1998 | Rosen |
| 5,936,916 | August 1999 | Nakayama et al. |
| 5,987,302 | November 1999 | Driscoll et al. |
| 6,532,448 | March 2003 | Higginson et al. |
| 6,578,008 | June 2003 | Chacker |
| 6,606,615 | August 2003 | Jennings et al. |
| 2001/0049648 | December 2001 | Naylor et al. |
| 2002/0120501 | August 2002 | Bell et al. |
| 2003/0014428 | January 2003 | Mascarenhas |
| 2003/0195795 | October 2003 | Chacker |
| 2004/0093249 | May 2004 | Chacker |
| 10033184 | October 2001 | Foroutan |
| 60302612 | July 2001 | Foroutan |
| 60242784 | October 2000 | Foroutan |

B) Reference to “Claim Number 2”: Advertising Supported Business Model

| Application Number | Filing date | Patent Number | Issue Date |
|---|---|---|---|
| 11/736243 | Apr. 17, 2007 | 7,526,436 | Apr. 28, 2009 |

Related U.S. Patent Documents to application Ser. No. 11/736,243

| Patent Number | Issue Date | Inventor |
|---|---|---|
| 6,609,105 | August 2003 | Van Zoest et al. |
| 6,632,992 | October 2003 | Hasegawa |
| 7,054,831 | May 2006 | Koenig |
| 2002/0178082 | November 2002 | Krause et al. |
| 2003/0014310 | January 2003 | Jung |
| 2005/0267813 | December 2005 | Monday |
| 2006/0229940 | October 2006 | Grossman |
| 2007/0061194 | March 2007 | Kikuchi |
| 2008/0097825 | April 2008 | Leach et al. |
| 60824984 | September 2006 | Brown |

Related Foreign Patent Documents

| Patent Number | Issue Date | Inventor |
|---|---|---|
| 2002083232 | March 2002 | JP |

### STATEMENT REGARDING FEDERALLY SPONSORED RESEARCH OR DEVELOPMENT

Not Applicable

### REFERENCE TO SEQUENCE LISTING A TABLE A COMPUTER PROGRAM LISTING COMPACT DISC APPENDIX

Not Applicable

### BACKGROUND OF THE INVENTION

a) Field of Invention

This “Business Model” is useful, leasable, sellable in the Entertainment Field, particularly, in the Music Industry. This is a “Transferable System”, applicable to any medium in the entertainment field that can be packaged, broadcasted, distributed, sold, or made accessible ONLINE.

b) Classification Definition

According to the U.S. Patent Classification System—Classification Definitions, for this “Business Model” is Class 705/500. Class Definition for 705/500 is Data Processing: Financial, Business Practice, Management, or Cost/Price Determination under “Miscellaneous”

This is the generic class for apparatus and corresponding methods for performing data processing operations, in which there is a method uniquely designed for or utilized in the management of an enterprise, or in the processing of financial data such as the combined flow of revenues generated from the profit from all areas of the music industry (such as but not limited to “concert tours” “retail selling albums/single records” “various types of merchandising deals” “various kinds of digital and online business(es)” and “publishing”) associated with entertainment product such as a recording artist or any other marketable and sellable entertaining and/or performing asset “across the board”.

c) Description of Prior Model

Although there has been no Patent associated with the current Business Model (ref. today's date Sep. 6, 2009) for the Music Industry to date, experts understand that Business Model is antiquated and is predicted to become obsolete within 10 years. The advent of Internet “file-sharing” and “digital downloading music” created a means for consumers to get the music they want for free. The total revenues for CDs, vinyl, cassettes and digital download in the U.S. dropped from a high of $14.6 billion in 1999 to $10.4 billion in 2008. The downward trend is expected to continue for the foreseeable future—Forrester Research predicts that by 2013 revenues will reach as low as $9.2 billion. This dramatic decline in revenue has caused large scale layoffs inside the industry driven music retailers out of business (such as Tower Records) and forced record companies record producers studios recording engineers and musicians to seek new business models.

### BRIEF SUMMARY OF INVENTION

Development of an eco-systemic business model for a Music Entertainment Company that will optimize use of a newly developed method and system for generating, processing and allocating revenues earned in the Music Industry, optimize the use of a newly developed Mechanical Royalty Rate Formula and new Mechanical Royalty Rate (to be Standardized within the Music Industry), and optimize the exploitation of entertainment assets such as (but not limited to) Record Artists and Music Catalogues, by implementing a new “Living 360° Music Entertainment Company” Business Model, which utilize the integration of various basic and transferable management and marketing strategies, business tools and business resources.

Note: If music shall become a “media” then a standardize rate for advertisers must be established. The Development of a Formula which will calculate and standardize the Mechanical Rate, conceptually designed with a Business to Business Model for Advertising Agencies and Media departments for Companies, and “other” will pay this rate in exchange for using the Music Content and Format as a Media to market their products and services (Ad Support Content). The old method is obsolete because it is a “broken system” and cannot generate a fair distribution of wealth for each vested entity within the music industry. This is a “New and Fair” royalty rates, residuals, and fee formula.

### THE FOLLOWING PAGES ARE DRAWINGS SEE ATTACHED

FIG. 1A (all pages 1 through 6) is the Mechanical Royalty Formula and Calculated rate. All arrows connect interrelated business departments and functions.

FIG. 2A (all pages 1 through 6) is the Eco-Systemic Business Model for Music Entertainment Company. All arrows connect interrelated business departments and functions.

FIG. 3A (1 page) is the Currently used (ref. Date Sep. 6, 2009) Business Model for the Music Industry

FIG. 4A (1 page) is a Currently used (ref Date Sep. 6, 2009) Business Model for the Television Broadcast Industry

### DETAIL DESCRIPTION OF THE INVENTION

### Introduction

### A Living 360° Production and Marketing Media Conglomerate Company

Clarifications

Consumers of Music Entertainment love and desire music at the same level or at a greater level than in the past. Therefore, declines in record sales have nothing to do with consumer interest or the quality of products.

The Consumer population of Music Enthusiast and Users is increasing. Therefore, a decline in record sales is unrelated since there is no decline in the number of potential music purchasers.

Potential Consumers who desire to obtain and possess a song, will and do. Therefore, a decline in record sales is unrelated since the number of potential purchasers of music has access to music and has obtained the music, yet most are not obtaining music by buying it.

The “old music industry business model” is broken, obsolete and no longer works. A new Business Model must be used if Record labels, Retailers, Music Producers, Managers, Promoters, Marketers, and Distributors, etc wish to continue making a living in this industry, or realize they must “get out” to stop losing money.

Identifies and defines the elements of business plans

The purpose of this business model is to establish a framework for creating economic, social, and/or other forms of value in the music entertainment business. Here, we establish core aspects of our business, including purpose, offerings, strategies, infrastructure, organizational structures, trading practices, and operational processes and policies.

How all these factors and elements inter-relate.

Consumer Behavior

Concert goers are Consumers of Music Entertainment and Fans of the Artist they chose to see.

Concert goers, Music Consumers, Radio Listeners, Television Audience, Internet Users, Magazine (Fanzine) buyers, and those who know or are a “Talented Protégé's” are all the same person.

### BUSINESS ECOSYSTEM

### An Excerpt Relating My Invention to James F. Moore Book Concept

Business Ecosystem is a strategic planning concept originated by James F. Moore and widely adopted in the high tech community starting in the early 1990s. The basic definition comes from Moore's book The Death of Competition: Leadership and Strategy in the Age of Business Ecosystems (Harper Business 1996).

The concept was introduced by Moore in the Harvard Business Review in May/June 1993 and won the McKinsey Award for article of the year.

Moore wrote—An economic community supported by a foundation of interacting organizations and individuals—the organisms of the business world. This economic community produces goods and services of value to customers who are themselves members of the ecosystem. The member organizations also include suppliers lead producers competitors and other stakeholders. Over time they co-evolve their capabilities and roles and tend to align themselves with the directions set by one or more central companies. Those companies holding leadership roles may change over time but the function of ecosystem leader is valued by the community because it enables members to move toward shared visions to align their investments and to find mutually supportive roles.

The ecosystem concept was widely used by Cisco Systems Inc throughout the world. The company leveraged partners for all business functions except for developing their core patented products and business strategy. Partners were used for sales marketing manufacturing technical support and new installations. Cisco lived up to the motto ‘do what you do best and leave the rest for others to do’. Until the 2002 technology bubble crash the company grew to be the largest valued and admired company in the world. This scalable business model allowed them to rapidly adapt and expand their operations using partners based on customer demand rather than slow risk based investments. The ‘locally global’ business model became the most respected business model in the communications industry of the 90s. While competitor crashed using old-world vertical models (e.g. Lucent Nortel and 3-Com) Cisco stepped in and took their markets and customer

### DESCRIPTION OF THE PREFERRED EMBODIMENT

### Business Model

### Component A

Redirect Music Industry Basis of Generating Income by establishing Music Industry Business to Business Model as the Primary, and its Business to Consumer as its Secondary Model
a) Establish Living 360° Production and Marketing Media Conglomerate Company as a Media Format for Advertisers.
b) The Living 360° Production and Marketing Media Conglomerate Company will produce Concert Tours, and Music Events, Globally. Company will book acts and format shows. Company will brand, package and market these Concert Tours, and Music Events, Globally. The Company will also continue to interact and conduct business with conventional Tour Agents, Talent Agents and Event Promoters for certain bookings of certain acts.
c) Establish National Network of Malls and Tours as Media; sell advertising opportunities to Corporations. Establish partnerships with Advertising Agencies and/or Corporations, hence. Also, included is a branded Syndicated Radio Program which will broadcast elements of concerts and specialty programmed music mixes and airplay formats, via radio, satellite radio and Internet stations, which will offer additional advertising opportunities to Advertising Agencies and/or Corporations. Broadcasts will also air via College radio stations which we will sponsor as charitable contributions to the educational institutions. Establish a Social Networking Website which will supplement consumer needs to interact before, during, and after concert event(s); purchase tickets, obtain music content digitally, obtain information about tour(s), and connect with artist(s) and other fans. Concerts will broadcast as live streaming or programmed as archives for user access viewing.
d) A measurable increase in demand and awareness for corporation's products and services whereas millions of people will be targeted and reached will establish Living 360° Production and Marketing Media Conglomerate Company as a prime Media Format option for Advertisers.
e) The Living 360° Production and Marketing Media Conglomerate Company will produce music based programming for TV Networks and Cable Networks, Radio, Satellite Radio, Internet Radio, Internet Streaming, and Internet Live Streaming programming. Company will have an established Internet website to broadcast shows. Shows will be syndicated and licensed to other broadcasters and markets associated with the internet, networks or cable television, satellite radio and radio. The Company will have an in-house production unit to accomplish the above. The Company will also, at times, outsource production service needs to accomplish the above.

The Living 360° Production and Marketing Media Conglomerate Company will market, provide and service and/or sell music to Consumers and Users via the Internet, at Concerts and Music Events, and Conventional Distribution Retail Outlets. The Company will establish a Website that will primarily market, provide and service and/or sell music to Consumers and Users. The Company will also produce Tours and Music Events, Globally that will allow company to market, provide and service and/or sell music to Consumers. Primarily, music will be “ad supported music”; in those instances consumers will not have to pay for music content.
g) The Living 360° Production and Marketing Media Conglomerate Company will sign Producers, Composers and Songwriters. Company will create and produce music and establish and own a catalogue of songs.
h) The Living 360° Production and Marketing Media Conglomerate Company will be a music publisher and own publishing and copyrights. Company will interact and conduct business and/or form partnerships with other music publishers and publishing administration companies. The Living 360° Production and Marketing Media Conglomerate Company will license its music to all various markets that can and will use music, globally.
i) At times the Living 360° Production and Marketing Media Conglomerate Company will accept music content from “independent song-pluggers” and will collaborate and conduct business with, and/or outright purchase rights of songs from other songwriters and composers.
j) The Living 360° Production and Marketing Media Conglomerate Company will use conventional methods to collect and account for royalties and fees due via use of established unions, public performance societies such as BMI, ASCAP & SESAC, mechanical royalties collecting agencies such as The Harry Fox Agency in the United States, and other such as Sound Exchange, when necessary.

### Business Model

### Component B

### Develop a Feeder Based Business Model

Establish a talent competition in each city we visit in our tours offering to the best talent an opportunity to be an “opening act”. The best talent would be signed to our Living 360° Production and Marketing Media Conglomerate Company, developed and managed. We will create the premise and establish the direction for new Recording Artist. Some Talents will be also signed as Producers, Singer/Songwriters, Composers, Musicians, Engineers, and Arrangers. Produce and Create hot cutting edge music and songs for Recording Artists (as well as for other recording artists and for licensing in films, TV, etc.). We will use the National Network of Malls, Syndicated Radio Program, Television Program, and Internet Streaming and Broadcasting to tour Recording Artist, play music, and showcase talent. Using the media element of the National Network of Malls, Syndicated Radio Program, Television Program, and Internet Streaming and Broadcasting to generate revenues from Corporations, or, from Advertising Agencies who manage the media budgets for corporations that purchase advertising will generate revenue to finance Tour, Syndicated Radio Program, Television Program, and Pre-pay for songs downloaded off our website, or any “iTunes” type online retailer (Ad Supported Music). Recording Artist(s), Producer(s), Songwriter(s), Tours, Internet, Radio Programs, TV Programs, and Company will be multi-branded and set up for merchandising opportunities.

### Business Model

### Component C

### Develop an Eco-Systemic Approach to Business

Establish a National Network of Malls to be used as primary venues for Concerts and Music Related Events; “Tour Route”. [Seasonal aspects: Outdoor “Drive-in” or “Parking Lot Outdoor Concert” option; otherwise primarily an in-door in-mall venue]

Produce Tour Packages to route through National Network of Malls for Music Businesses such as Labels, Distributors, Managers, Agents, and, for our own “Living 360° Production and Marketing Media Conglomerate Company”.

Establish National Network of Malls and Tours as Media; sell advertising opportunities to Corporations. Establish partnerships with Advertising Agencies and/or Corporations, hence. Also, included is a branded Syndicated Radio Program which will broadcast elements of concerts and specialty programmed music mixes and airplay formats, via radio, satellite radio and Internet stations, which will offer additional advertising opportunities to Advertising Agencies and/or Corporations. Broadcasts will also air via College radio stations which we will sponsor as charitable contributions to the educational institutions. Establish a Social Networking Website which will supplement consumer needs to interact before, during, and after concert event(s); purchase tickets, obtain music content digitally, obtain information about tour(s), and connect with artist(s) and other fans. Concerts will broadcast as live streaming or programmed as archives for user access viewing. Those who know or are “Talented Protégé's” of top performers can upload their own renditions of performances and show their talent. These individuals will be granted the opportunity to partake in competitions that may lead to signing with our “Living 360° Production and Marketing Media Conglomerate Company”; which will allow the winner to record, tour, and merchandise their name and likeness and develop their own fan base and success. Eventually, a music entertainment show format will broadcast on network and/or cable television as well.

Discover and Sign, Develop, and Manage Recording Artist's Career. Create the premise and establish the direction Recording Artist. Discover and Sign, Develop, and Manage Producers, Singer/Songwriters, Composers, Musicians, Engineers, and Arrangers. Produce and Create hot cutting edge music and songs for Recording Artists (as well as for other recording artists and for licensing in films, TV, etc.). We will use the National Network of Malls, Syndicated Radio Program, Television Program, and Internet Streaming and Broadcasting to tour Recording Artist, play music, and showcase talent. Using the media element of the National Network of Malls, Syndicated Radio Program, Television Program, and Internet Streaming and Broadcasting to generate revenues from Corporations, or, from Advertising Agencies who manage the media budgets for corporations that purchase advertising will generate revenue to finance Tour, Syndicated Radio Program, Television Program, and Pre-pay for songs downloaded off our website, or any “iTunes” type online retailer (Ad Supported Music). Recording Artist(s), Producer(s), Songwriter(s), Tours, Internet, Radio Programs, TV Programs, and Company will be multi-branded and set up for merchandising opportunities.

### TOUR PRODUCTION AND PROMOTION CORPORATE SPONSORS STRATEGY

There are 7 Types of Sponsors that are not likely to create a problem regarding “market interference placement” for this Tour and can benefit greatly from the exposure:

### Auto Manufacturers

Ford Motors, General Motors, Chrysler, Toyota, Honda, Nissan, Mercedes, etc.

### Banks & Financial Institutions

Citibank, Chase, HSBC, Bank of America, Wachovia, etc.

### Insurance & Securities Firms

Goldman Sachs, MetLife, All State, Merrill Lynch, GHI, Aetna, GIECO, etc.

### Computers & Electronics

Hewlett Packard, IBM, Microsoft, Apple, Panasonic, SONY, etc.

### Health & Medical Products

Bayer, Pfizer, Merck, Colgate-Palmolive, Tylenol, etc.

### Cell Phone Equipment & Service Providers

Verizon, T-Mobile (Danger), AT&T, Motorola, Nokia, etc.

### Food & Beverage

Pepsi, Coke, Dr. Pepper, M&M's, Kraft, Tropicana, Campbell Soup Company, etc.

We will not have more than one Sponsor Industry per Sponsor sector; for example, if Event Sponsor is an Electronics/Computer company, the Fashion and Stage Sponsor cannot be from that industry.

Insurance and Medical Sponsors may be inappropriate for the Fashion Sponsorship Sector

### Corporate Sponsors

This is a National Tour. Over 125 Million or more consumers will be introduced, reminded, exposed to a product or service of any corporate sponsor, and stimulated to buy a product or service sold by the corporate sponsor.

The aftermath of each event and the entire tour will generate massive Publicity which will continue to expose a product or service of any corporate sponsor to over 200 Million Consumers who read Newspapers, magazines and listen to Radio, and, stimulated those same consumer to possibly buy a product or service sold by the corporate sponsor.

The corporate sponsor's product or service brand and company's repertoire will resound each year as the event occurs, as well as throughout the year, as this event will be highly anticipated by Consumers in various cities. This event will be a ritualistic enjoyment and community driven occasion. Millions of Consumers nationwide will be introduced, reminded, exposed to a product or service of any corporate sponsor, and stimulated to buy a product or service sold by the corporate sponsor, each time the event is referred to in each community. The fundraising will benefit children with Autism, children challenged with social-economic depravity, and the Simon Youth Foundation (SYF) which foster and improve educational opportunities, career development, and life skills for at-risk youth through focused programs and initiatives with our public school partners, as well as offer scholarships.

### A Corporate Sponsor can:

1—Sponsor the Event (example AT&T): all radio, print, TV, etc ads will read or say;

AT&T Presents the Taste of [City] Food Festival at RiverEdge Mall

Come sample some of [City's] best cuisines and entrée's while you also

“Shop til Ya Drop”

Featured performances by Alicia Keys . . . .

On the Tour Bus the Product will be displayed as presenting sponsor to be seen as we travel across the country

2—Sponsor the Stage (example Maxwell House): all radio, TV, print ads will say;

“ . . . Don't Miss Ms. Alicia Keys, Live on Stage at RiverEdge Mall, this announcement is brought to you by Maxwell House, good to the last Drop! . . . ”

On the stage, there will be a large display banner “Colgate” and the Host will consistently thank Colgate for “this Segment”.

3—Sponsor the mall's Fashion Show (example Panasonic): all radio, TV, print ads will say;

“ . . . The RiverEdge Mall, invites you to see some of today's latest fashions at the Panasonic Fashionista Runway . . . Be there, and watch 'em Vogue! . . . ”

On the Fashionista Program pamphlet Panasonic will be displays as presenting sponsor of the Fashion Show segment.

The Pamphlet will be a mini-magazine showcasing models wearing various items, some of which that will be modeled live at the Panasonic Fashionista Runway.

### TOUR PRODUCTION AND PROMOTION FOOD TASTING FESTIVAL WITH PARTICIPATING RESTAURANTS & SPECIALTY FOOD OUTLETS

Each restaurant that is invited to partake in this event and display to the public their menu of various entrée's and special foods with a variety of foods ranging from Ice Cream to Steak Dinners will register per City.

“A Taste of . . . ” RESTAURANT SHOWCASE

Restaurants in your Mall and Mall's Neighboring Vicinity will eagerly embrace “A Taste of [Your Mall's Name and Town] Food Festival” where each restaurant is given the opportunity to present its best dishes to the public during this eventful extravaganza. A “fair” is set up and restaurant owners’ offer samples of their best food dishes to throngs of your hungry shoppers and town citizens. The festival is complimented by Live Musical Entertainment, a Mall Fashion Show, and Popular Comedian Host!

### Mall Fashion Show

The Mall's boutiques and department stores are invited to participate in the Fashion Show at no expense to them. They can enter employees from their store to model fashions they'd like the Attendee's of this event to see and possibly buy!

### 8.6—TOUR PRODUCTION AND PROMOTION INVOLVEMENT WITH CHARITIES

Example of possible charities we will work with:

### Simon Youth Foundation

The mission of Simon Youth Foundation (SYF) is to foster and improve educational opportunities, career development, and life skills for at-risk youth through focused programs and initiatives with our public school partners. To achieve our mission, SYF has two primary programs that it focuses its time and resources on.

### The Hawthorne Foundation

The Hawthorne Foundation is a private, not-for-profit organization that has for over 28 years provided an education to children who are challenged by serious disabilities. In 1981, the Margaret Chapman school (predecessor to Hawthorne Country Day School), became the first ABA (applied behavior analysis) based educational program to provide services to children who were diagnosed with severe developmental disabilities, autism, and other behavior disorders. HCDS is the longest running and most successful ABA program in New York State. Over subsequent years, we have expanded our programs to include a full continuum of care for children, birth to adulthood.

### Teens In Motion

Teens In Motion is a non profit organization created to offer teens of the Bronx the opportunity to develop their minds and bodies in a safe and secure environment. The primary methodology for reaching youth is to rely on the peer group relationships that are formed by the young people. We offer teen activities they'll enjoy such as dancing, singing, drama, modeling, spoken word, and life skill workshops that help to boost their self esteem. Our hope is to offer teens that have trouble in their homes shelter, education, and direction to better their lives and to achieve their dreams. Alicia Keys is a spokes person for Teens In Motions and was a former member.

### WEBSITE

The awe-inspiring advantages the internet has provided to expand marketing's essential function in today's business strategies, is impacting. It has deeply integrated itself as an important routine option for reaching consumers and creating an awareness and demand for product. It is quickly adapting many of the uses and benefits Television, Cell Phones, HD/DVD Formats, Podcasts and WiFi and many other digital formats has developed into in recent years, which include social networking, entertainment, news, as an educational tool, and for marketing. Today, the interactive element that the internet provides makes it a much more potent medium for all these areas. We present to you (TBA) . . . . [Working Brand name: Palladium.Com, herein]

### Lifestyle Driven Marketing.

The nucleus of self image thrives on impressions and taste. Many trends evolve into an actual culture when the social element manifest the combined self-image of each fan of the particular movement, and unwittingly, a system of shared beliefs, values, customs, behaviors, and symbols becomes a standard that the members of that society use to cope with the world and with one another. It becomes strong enough to survive from generation to generation. Uniquely, this evolution is very fast and usually first appears in art.

Music, as an art form is a powerful vehicle for expression an idea or feeling. In business, observing how one targeted consumer group may insure a greater potential for profit than another, places music as a prime utility, best for achieving a plan and to reach a choice demographics. If you desire to reach young urban demographics, Hip Hop music would help. If you see an older mature clientele as your targeted consumer, Jazz may be a better fit. Nevertheless, music covers a kaleidoscope of cultures and social groups, specifically, and can help edify any business' strategy of increasing the demand and awareness of whatever being sold.

### THE PROBLEM WHICH NEEDED TO BE SOLVED

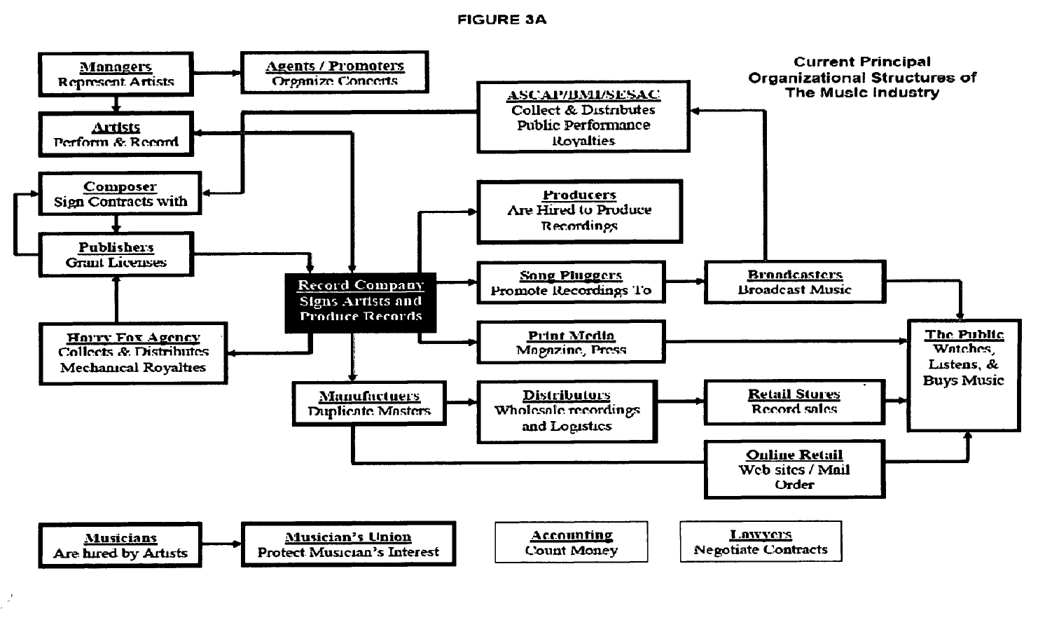

### Current (Antiquated) Business Model for Music Entertainment Business (See FIG. 3A)

### Music Business Structure (Current Year 2009 & Prior)

The music industry is made up of various players including individual's companies unions not-for-profit associations rights collectives and other bodies. Professional musicians including band leaders rhythm section members musical ensembles vocalists conductors composers/arrangers and sound engineers create sound recordings of music or perform live in venues ranging from small clubs to stadiums. Occasionally professional musicians negotiate their wages contractual conditions and other conditions of work through Musicians' Unions or other guilds. Composers and songwriters write the music and lyrics to songs and other musical works which are sold in print form as sheet music or scores by music publishers. Composers and performers get part of their income from writers' copyright collectives and performance rights organization such as the ASCAP and BMI (or MCPS and PRS respectively for the UK). These societies and collectives ensure that composers and performers are compensated when their works are used on the radio or TV or in films. When musicians and singers make a CD or DVD the creative process is oftentimes coordinated by a record producer whose role in the recording may range from suggesting songs and backing musicians to having a direct hands-on role in the studio coaching singers giving advice to session musicians on playing styles and working with the senior sound engineer to shape the recorded sound through effects and mixing.

Some professional musicians bands and singers are signed with record labels which are companies which finance the recording process in return for part or full share of the rights in the recording. A record company is an entity that manages sound recording-related brands and trademarks which consist of their owned labels; their owned and licensed master recordings; and various related ancillary businesses such as home video and DVDs. Labels may comprise a record group which is in turn controlled by a music group. As such a larger umbrella label may have a number of sub-labels releasing music. Music publishers exist separately (even if sharing the same ultimate holding company or brand name) and they represent the rights in the compositions—i.e. the music as written rather than as recorded.

Record companies and record labels that are not under the control of the “Big Four” music groups and music publishers that are not one of these four groups are generally considered to be independent or “indie” labels even if they are part of large well-financed corporations with complex structures. Some music critics prefer to use the term indie label to refer to only those independent labels that adhere to criteria of corporate structure and size and some consider an indie label to be almost any label that releases non-mainstream music regardless of its corporate structure. According to US Market Research Firm NPD Group iTunes recently surpassed Wal-Mart as America's largest music distributor. A record distributor is a company (often a record label) that works with record labels to promote and distribute their records either in their home market or overseas.

Once a CD is recorded record distributor companies organize the shipping of the CDs to music stores and department stores. Record labels have use an “A&R” (Artists and Repertoire) manager to help develop the performing style of bands and singers signed the label. A&R managers may organize shared tours with similar bands or find playing opportunities for the label's groups which will broaden their musical experience. For example an A&R manager may decide to send an emerging young singer-songwriter with little live playing experience on a major tour with an established electric folk rock act from the same label so that this person will gain more confidence.

When CDs sell in stores or on websites such as iTunes part of the money is returned to the performers in the form of royalties. Most recordings only earn royalties for a short period after they are released after which the song becomes part of the “back catalogue” or library. A much smaller number of recordings have become “classics” with longstanding popularity such as albums by the Beatles or the Rolling Stones. These albums have continued to earn royalties for the surviving band members decades after their original release date.

Successful artists will hire a number of people from other fields to assist them with their career. The band manager oversees all aspects of an artist's career in exchange for a percentage of the artist's income. An entertainment lawyer assists them with the details of their contracts with record companies and other deals. A business manager handles financial transactions taxes and bookkeeping. A booking agency represents the artist to promoters makes deals and books performances. A travel agent makes travel arrangements. A road crew is a semi-permanent touring organization that travels with the artist. This is headed by a tour manager and includes staff to move equipment on and off-stage drive tour buses or vans and do stage lighting live sound reinforcement and musical instrument tuning and maintenance. The tour manager's tasks can vary widely depending on the type of tour and where the group is playing. The tour manager's typical tasks of ensuring that hotel restaurant and travel arrangements are confirmed may expand into other tasks if the venue where the band is playing does not have certain equipment. If the venue lacks a grand piano or Hammond organ that the band needs for the show the tour manager will be responsible for finding a rental instrument for the show and having it moved onstage; as well if a band member needs an emergency instrument repair the tour manager and/or the guitar tech will help to find a repair person or replacement instrument. The most high-profile celebrity performers may also have personal assistants a chef and bodyguards. Singers may hire a vocal coach to give them suggestions on how to take care of their voice or develop their singing range.

### The Music Business History

The music industry (or music business) sells compositions recordings and performances of music. Among the many individuals and organizations that operate within the industry are the musicians who compose and perform the music; the companies and professionals who create and sell recorded music (e.g. music publishers producers studios engineers record labels retail and online music stores performance rights organizations); those that present live music performances (booking agents promoters music venues road crew); professionals who assist musicians with their careers (talent managers business managers entertainment lawyers); those who broadcast music (satellite and broadcast radio); journalists; educators; musical instrument manufacturers; as well as many others.

In the late 19th century and early 20th century the music industry was dominated by the publishers of sheet music. By mid-century records had supplanted sheet music as the largest player in the music business. Since 2000 sales of recorded music have dropped off substantially while live music has increased in importance.

There are four “major labels” that dominate recorded music—Universal Music Group Sony Music Entertainment Warner Music Group and EMI—each of which consists of many smaller companies and labels serving different regions and markets. The live music industry is dominated by Live Nation the largest promoter and music venue owner. Live Nation is a former subsidiary of Clear Channel Communications which is the largest owner of radio stations in the United States. Other important music industry companies include Creative Artists Agency (a management and booking company) and Apple Inc. (which runs the world's largest music store iTunes Store and sells the iPod and iPhone).

### Evolution of the Music Industry

1700s and 1800s

Until the 1700s the process of composition and printing of music was for the most part supported by patronage from aristocracies and churches. In the mid-to-late 1700s performers and composers such as Wolfgang Amadeus Mozart began to seek commercial opportunities to market their music and performances to the general public. After Mozart's death his wife (Constanze Weber) continued the process of commercialization of his music through an unprecedented series of memorial concerts selling his manuscripts and collaborating with her second husband George Nissen on a biography of Mozart. In the 1800s the music industry was dominated by sheet music publishers. In the United States the music industry arose in tandem with the rise of blackface minstrelsy. The group of music publishers and songwriters which dominated popular music in the United States was known as Tin Pan Alley.

1900s

In the early 20th century the phonograph industry grew greatly in importance and the record industry eventually replaced the sheet music publishers as the industry's largest force. A multitude of record labels came and went but a handful of label corporations prospered for decades. By the end of the 1980s the “Big 6”—EMI Sony BMG PolyGram WEA and MCA—dominated the industry. In mid-1998 PolyGram merged into Universal Music Group (formerly MCA) dropping the leaders down to a “Big 5”. They became the “Big 4” in 2004 when Sony merged with BMG.

2000s

In the 21st century consumers spent far less money on recorded music than they had in 1990s in all formats. Total revenues for CDs vinyl cassettes and digital downloads in the U.S. dropped from a high of $14.6 billion in 1999 to $10.4 billion in 2008. The downward trend is expected to continue for the foreseeable future—Forrester Research predicts that by 2013 revenues will reach as low as $9.2 billion. This dramatic decline in revenue has caused large scale layoffs inside the industry driven music retailers out of business (such as Tower Records) and forced record companies record producers studios recording engineers and musicians to seek new business models.

In the early years of the decade the record industry took aggressive action against illegal filesharing successfully shutting down Napster in 2001 (the leading online source of digital music) and threatening thousands of individuals with legal action. This failed to slow the decline in revenue and was a public relations disaster. Some academic studies have even suggested that downloads were not the true cause of the decline. Legal digital downloads became widely available with the debut of the iTunes music store in 2001. The popularity of internet music distribution has increased and by 2007 more units were sold over the internet than in any other form. However as the Economist reports “paid digital downloads grew rapidly but did not begin to make up for the loss of revenue from CDs.”

The turmoil in the industry has changed the balance between artists record companies promoters retail music stores and the consumer. The leading music retailers are now box stores (Wal-Mart and Best Buy) and music-only stores are no longer a player in the industry. Recording artists now rely on live performance and merchandise for the majority of their income which in turn has made them more dependent on music promoters like Live Nation (which dominates tour promotion and owns a large number of music venues.) In order to benefit from all of an artist's income streams record companies are increasingly relying on the “360 deal” a new business relationship pioneered by Madonna who signed with Live Nation in 2007. At the other extreme record companies can offer a simple manufacturing and distribution deal which gives a higher percentage to the artist but does not cover the expense of marketing and promotion. Many newer artists no longer see any kind of “record deal” as an integral part of their business plan at all. Inexpensive recording hardware and software has made it possible to create high quality music in a bedroom and distribute it over the internet to a worldwide audience. Consumers now have access to a wider variety of music than ever before at a price that is gradually approaching zero.

### Necessity to Evolve Once More

Today, the current Music Industry business model is obsolete. There is no way the industry will be able to stop the downloading and/or the copying of masters, digitally by consumers who want the music, who has a computer with internet access, and do not want to pay for the music if “peer to peer file sharing” technology exist. It is time to reinvent the Music Industry premised on my Invention and it's components herein. The Music Industry must now evolve to mirror the Television Broadcasting Industry, which is total Ad Supported Content. The Music Industry must allow music to become a Media.

### RESEARCH EXCERPT

### The Traditional Television Business Model and Video on Demand Posted by Martino Mingione on Nov. 28, 2005

Ultimately there are two immovable parties in television: the people who create something worth watching and the audience. Without either there is not much a business. Everyone else is an intermediary: broadcasters networks stations cable operators satellite providers Internet TV portals Telco's television guides set top box makers etc. These intermediaries exist only so long as they fulfill a function that cannot be economically replaced with some viable alternative.

In Diagram FIG. 4A on Page 7, the important takeaway is that when well established rules exist each party is free to seek a business advantage without owning the whole ecosystem. For example the networks know that most of their revenue comes from the $27 B in national ad revenue with their main expense being the studios. TV stations allocated ad inventory to compete for part of the $25 B in spot advertising with their expenses being station management. Cable companies get 88% of their revenue from subscriptions with 12% coming from an additional $5 B in spot advertising. Their primary expenses are plant operations and network carriage fees.

Diagram FIG. 4A on Page 7, is a generalization of the business. Each sector (broadcast cable and satellite) have unique specifics. Some companies participate in multiple boxes. NBC for example has some studios is a network and owns 13 stations. IPTV will look more like cable when it is deployed.

The best content still comes from the traditional studio mechanism. Until studios test changes to their business model broadcast and cable networks like CBS and USA (for example) will still loom large. Recent news indicates that the networks are leveraging this power by looking only for incremental revenue streams through new distribution channels. In terms of the picture above they test system operator changes; put 100% dependence upon viewer fees for revenue; and ignore advertiser subsidization.

The last few weeks have seen a host of business deals aimed at making it easier for television viewers to watch shows whenever and wherever they choose. These new arrangements include NBC and CBS's plans for 99-cent video-on-demand and Apple's iPod link-up with ABC for $1.99 per episode.

The Apple iPod deal with ABC tests one possible idea about how mobile non-linear viewing might be monetized. Apple is a new player in the equation but what they are testing is the use of their iTunes web site as an alternative distribution mechanism replacing the stations and cable companies. Their iPod is a replacement for the television itself. Expect more things like this as cell phones gear up for big offerings next year.

The CBS deal is the same experiment sans the word ‘mobile.’ It too is an experiment that keeps the existing network fully in control of the non-linear viewing process. CBS still airs it popular content on linear television still collects significant ad revenue from advertisers and uses Comcast's VOD servers as an alternative distribution mechanism.

The Wall Street Journal points out that “these pacts might give the networks added leverage in their contention that they should be compensated by cable and satellite companies who distribute the broadcasters' signal into the vast majority of U.S. homes.”

. . . “For years broadcasters and local television stations have been frustrated that cable carriers shell out fees to . . . cable networks based on the number of subscribers . . . but pay nothing to transmit the signals of ABC NBC Fox and CBS . . . So for example big cable companies like Time Warner Inc. or Comcast pay 55 cents to General Electric Co.'s USA Network for every household that receives the cable signal.”

The gist of their article is that these experiments are supposed to give the networks leverage in eventually extracting carriage fees from Comcast and Time Warner. The article fails to mention that USA Network also turns over to the cable companies 2 minutes per hour for local ad insertion—something that ABC CBS and NBC would never accept.

But if the WSJ is correct about the broadcaster's thinking then that strategy misses out on the real opportunity: determining how Comcast and CBS might eventually scrap the whole carriage fee idea that works only in linear television. In its place they could put a new arrangement that splits up non-linear advertising dollars amongst the parties.

The entrepreneur in me keeps a close eye on the ABC and CBS experiments because what they are really testing is whether the viewer is willing to pay ever more money to watch non-linear video. I suspect that both experiments will fail to create any enduring revenue streams. But the unintended success might be in forging the business relationships between powerhouse broadcasters and cable companies VOD distribution.

This step is necessary to support a sustainable business model for non-linear television. If I had to sum up what is missing before VOD can take off it is this: the parties do not yet know how to seek a business advantage without owning the whole ecosystem. This is in sharp contrast to the linear model.

What's apparent is that consumers appear to be clear winners as competing sides of the entertainment industry jostle for their attention. But the group most ignored in the debate is the one that theoretically could gain the most from the shift in how consumers watch television: writers and producers. Traditionally this group negotiates with networks for distribution. The networks really are a branding and promotion business that assumes the risks associated with advertising by shifting it off of the producers. A truly radical change to the business model will occur when they begin experimenting in new ideas.

### REFERENCE

### Bibliography Reference

1) “FIG. 3A” on Page 9 is the copyright of Planet Of Tunes© 1999-present day. http://www.planetoftunes.com/industry/industry_structure.htm
2) “Music Business Structure” Page 9-Page 10 is copyright of Wikipedia© 2002-present day: major contributors The Major Record Label Companies. http://en.wikipedia.org/wiki/Music_industry
3) Article: “The Traditional Television Business Model And Video on Demand” Posted by Martino Mingione on Nov. 28, 2005 08:52 AM http://www.reinventtv.com/archives/2005/11/the_traditional.html
4) “Mashable” The Social Media Guide http://mashable.com/2009/05/08/facebook-twitter-myspace-growth-april/
5) Currency Converter http://finance.yahoo.com/currency-converter#from=USD;to=CNY;amt=1
6) “The Death of Competition: Leadership and Strategy in the Age of Business Ecosystems” by James F. Moore (Harper Business 1996).
7) So Many Albums Released, So Few Buyers” Posted by Dan Calladine—Thursday, Jul. 9, 2009

As a short follow up to my review of Chris Anderson's Free earlier this week, here is a quote from an article in today's DigitalMusicNews:

“At the recent A2IM (American Association of Independent Music) annual gathering in New York, some scary numbers were floating around. According to Nielsen Soundscan, a total of 105,000, new full-length albums were released in 2008, a fourfold gain from the earlier 2000s. And of that pot, just 6,000 releases sold 1,000 units or more in the first year. Across the pond, similar information emerged. During a DIY discussion at Musexpo Europe in London last week, industry consultant Keith Jopling noted that over 30,000 albums are released every year in the United Kingdom, a 30 percent gain since 2000. Other markets are undoubtedly experiencing similar booms, based on the ability of any artist to create cheaply, upload instantly, and build fan-bases directly.”

That figure of only 6,000 selling more than 1,000 in the first year (presumably they only count the first year) is extraordinary. The same issue of Digital Music News also reports: “US-based album sales during the first half were down 14.7 percent year-over-year, across all formats—CD, LP, digital album download, etc. The tally for the first 26 weeks was 174.5 million units.”

Alan McGee's line about the digitalization of music is that it means that people who make music will be the people who want to express themselves, rather than the ones who are trying to make money is vindicated in this. Music always was a hobby to most, but now even more so.

http://digital-examples.blogspot.com/2009/07/so-many-albums-released-so-few-buyers.html

1. We claim: New method and system for generating, processing and allocating revenues earned in the Music Industry using new “Living 360°” Business Model, utilizing and integrating various basic and transferable management strategies, tools and resources.
I—Living 360 Business Model's management strategy solution
a) Method: Utilizing an Eco-systemic Approach to Business and a Marketing Plan
b) System: Integration of
i. Recording Artist's Career and Development Management Strategies
1. Production, Recording Album and Album Distribution into Market
2. Touring Cycle Planning Strategy for Recording Artist
3. Merchandising and Marketing Strategy for Recording Artist
c) Processing of Revenue: Accounting using an Accounting Software and Sub-Ledger Accounts for Allocation
d) Allocation of Revenue: The Living 360° Formula for Royalty, Residual, and Fees (See FIG. A.2)
II—Living 360 Business Model's management tools
a) Method: Utilizing Electronic, Computerized technology and Communication, and Modern Logistics with Upgradeable Software
b) System: Integration of
i. Internet full scope and use
ii. Business management tool including (but not limited to) Accounting Software
iii. Communication networks, use of purpose, and devices including (but not limited to) Internet, cellular, any wireless use and purpose, broadcast set up and use, and recording utilities
iv. Modern Logistic and distribution network and purpose including any and all types of parcel delivery processes, Internet based distribution, and Inventory recording and processing
v. Statistical analysis, qualitative and quantitative analysis process by utilizing “in-place” systems and solutions such as (but limited to):
1. Soundscan: Count No. of Units received by Consumer
2. Sound Exchange: Count No. of Times Music is Broadcasted on the Internet
3. Harry Fox Agency: Monitor's Mechanical interest
4. ASCAP: Count No. of Times Music is Broadcast
5. BMI: Count No. of Times Music is Broadcast
6. SESAC: Count No. of Times Music is Broadcast
7. Publishers: Monitor's Publishing interest
8. R.I.A.A.: Statistical Analysis of Albums in Market
c) Processing of Revenue: Collecting of Data and Statistics for Allocation
d) Allocation of Revenue: The Living 360° Formula for Royalty, Residual, and Fees (See FIG. A.2)
III—Living 360 Business Model's management resources
a) Method: Utilizing Human Resources and Eco-systemic Properties
b) System: Integration of
i. Ecosystemic properties we own:
1. Production Company—create and produce asset
2. Management Company—manage, merchandise, brand, and exploit asset
3. Recording Facility—Record and master music
4. Tour Package—Promote asset and deliver entertainment and performance to consumer audience
5. Distribution Network—Market asset and deliver asset and performance to consumer
6. Broadcasting Network—Broadcast asset to consumer audience
7. Database and Logistic and Research—Deliver asset to consumer; monitor demographics and other statistics
8. Institute for Development—Artist (asset) Development
9. Talent Search Brand—Talent Competition encourages potential assets to come to our enterprise; develop underlying grass-roots marketing exposure; a screening process for choosing asset
ii. Human Resources at all properties and interrelated
c) Processing of Revenue: Not Applicable
d) Allocation of Revenue: Not Applicable

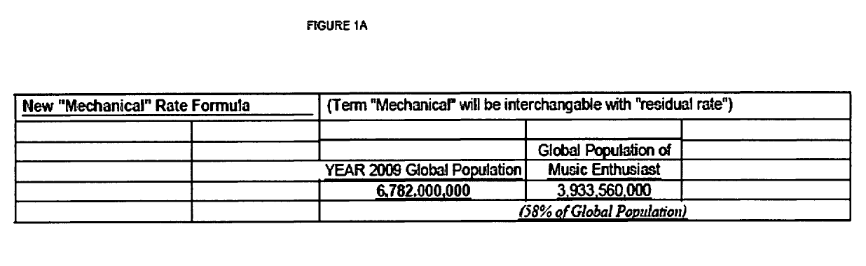

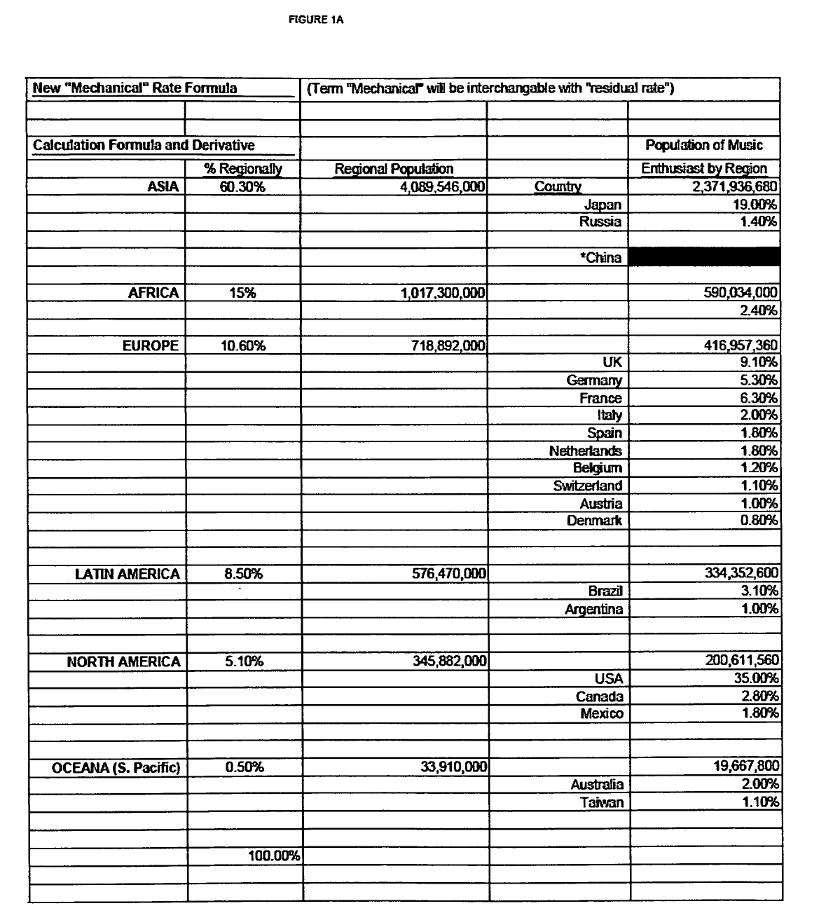

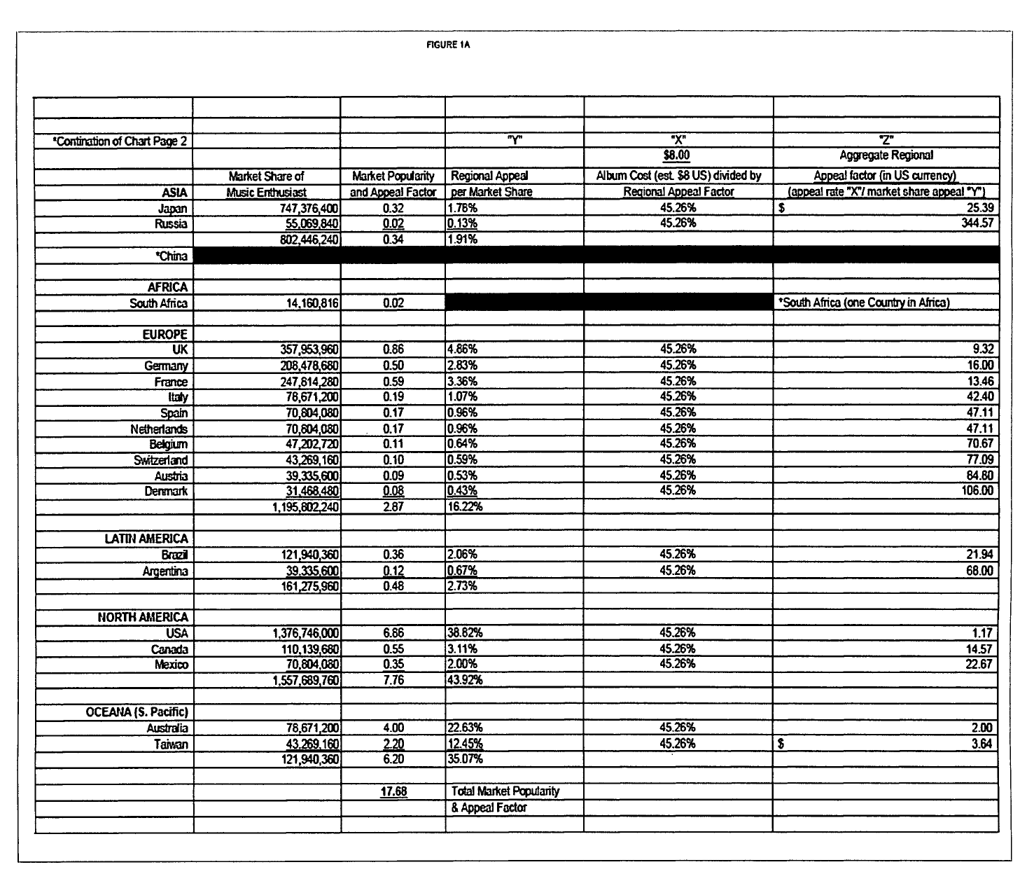

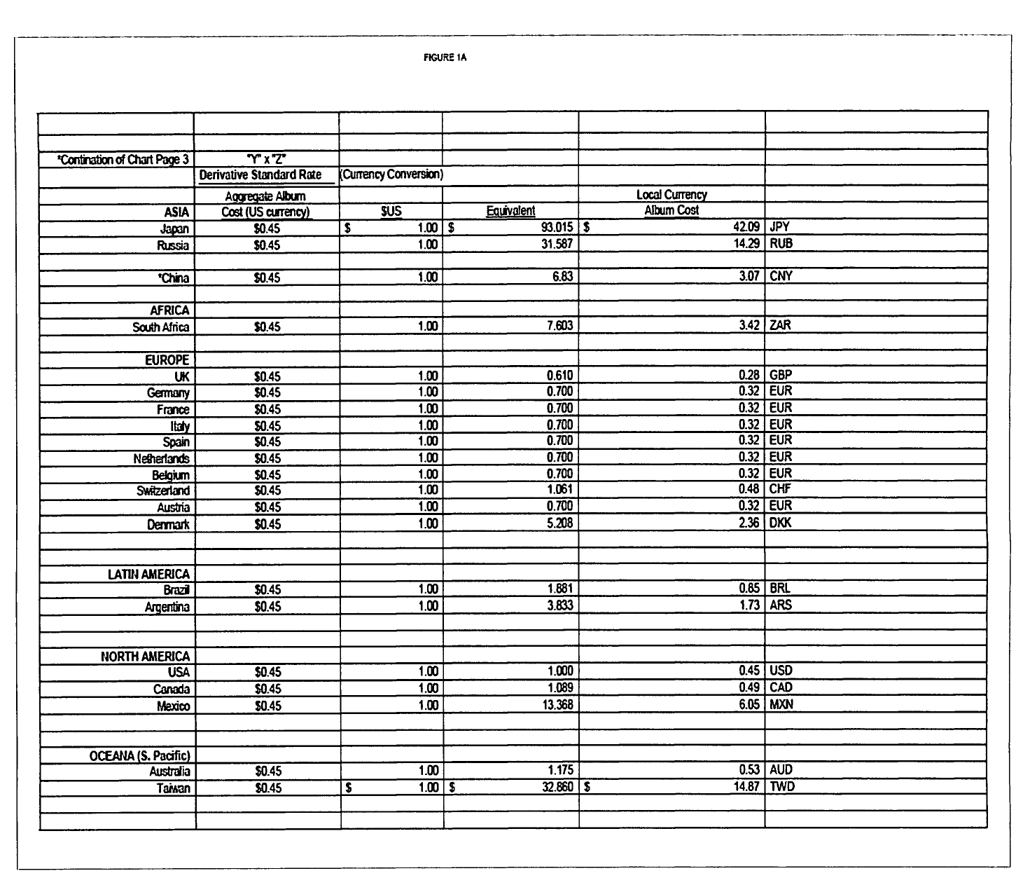

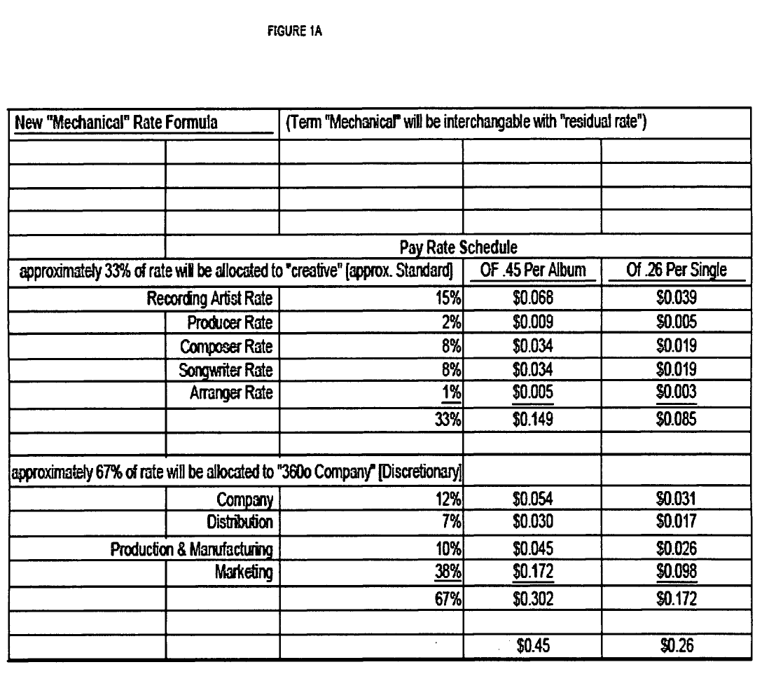

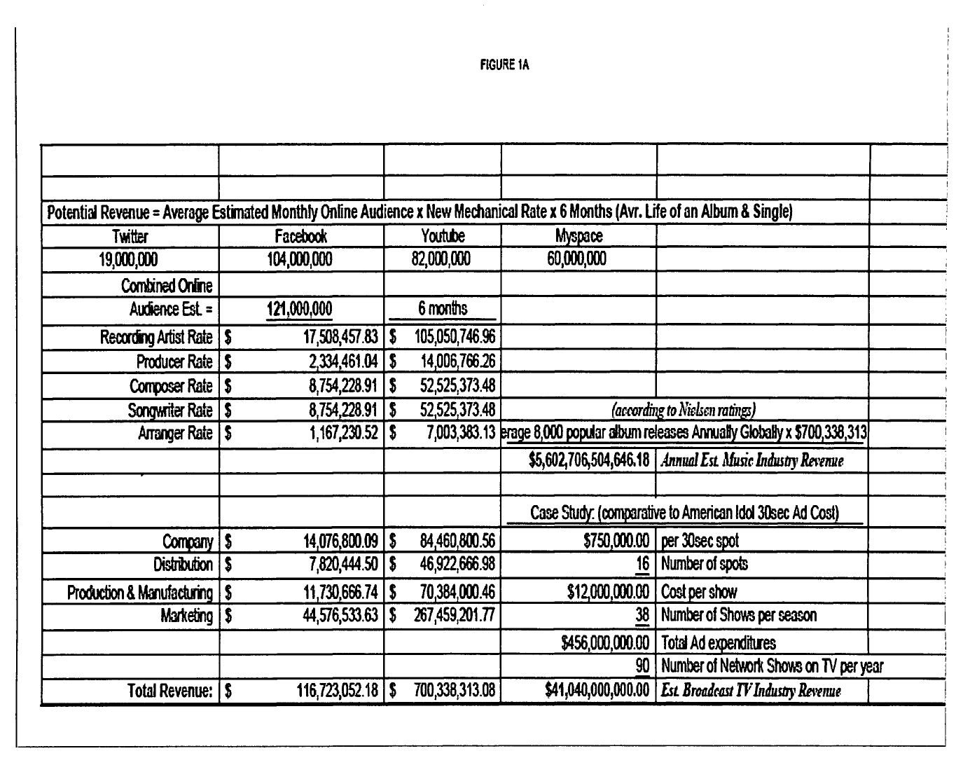

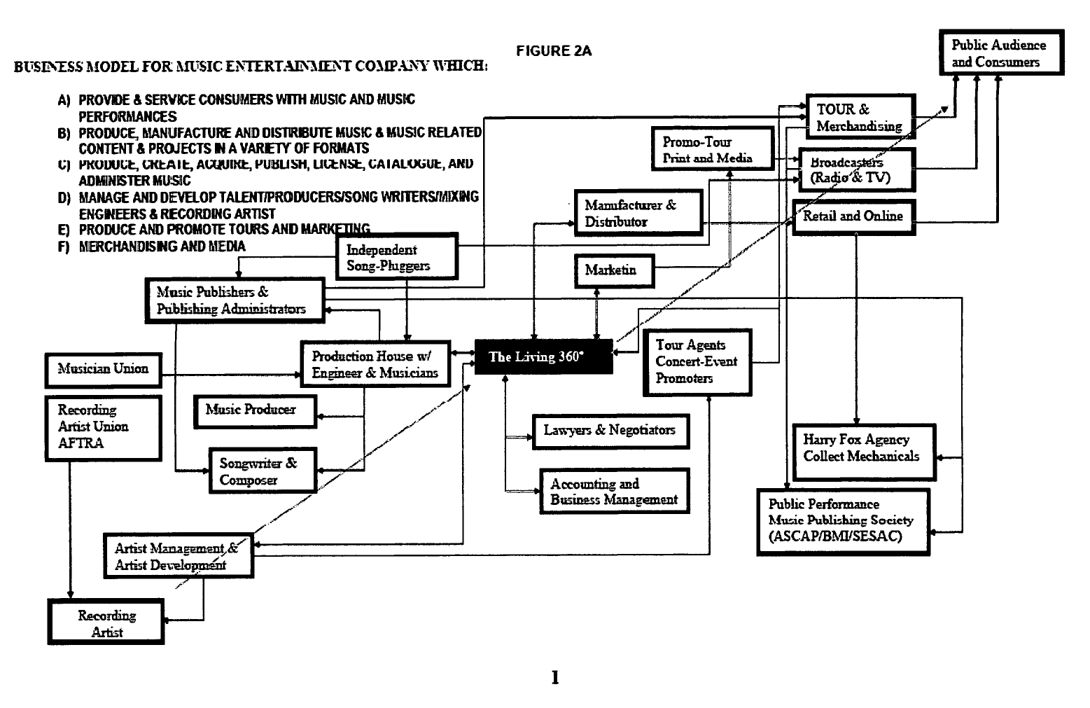

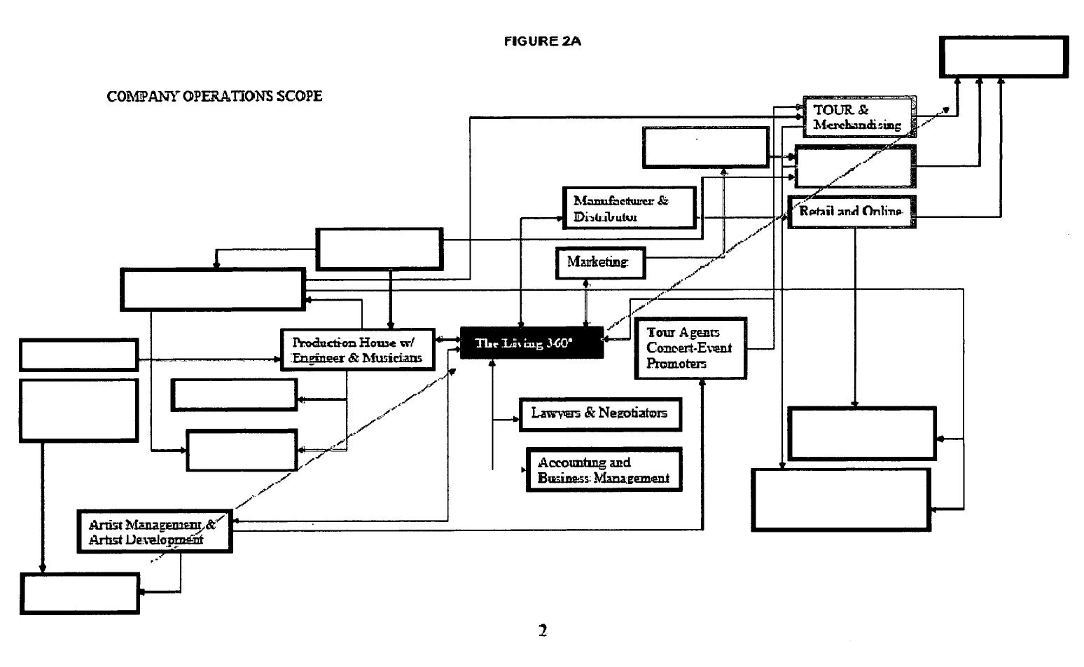

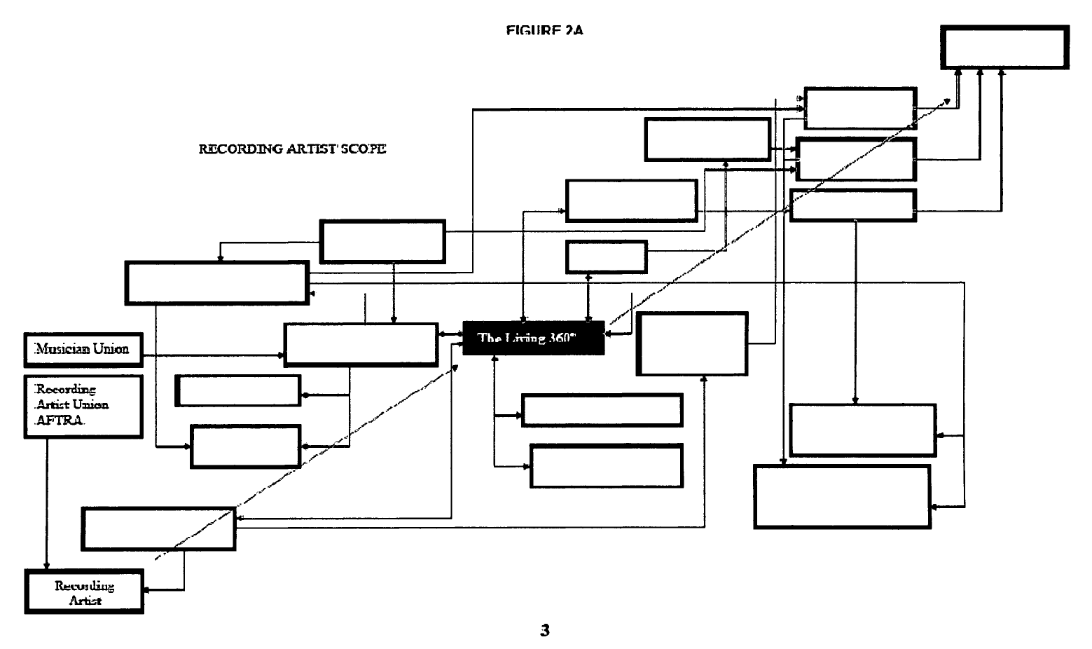

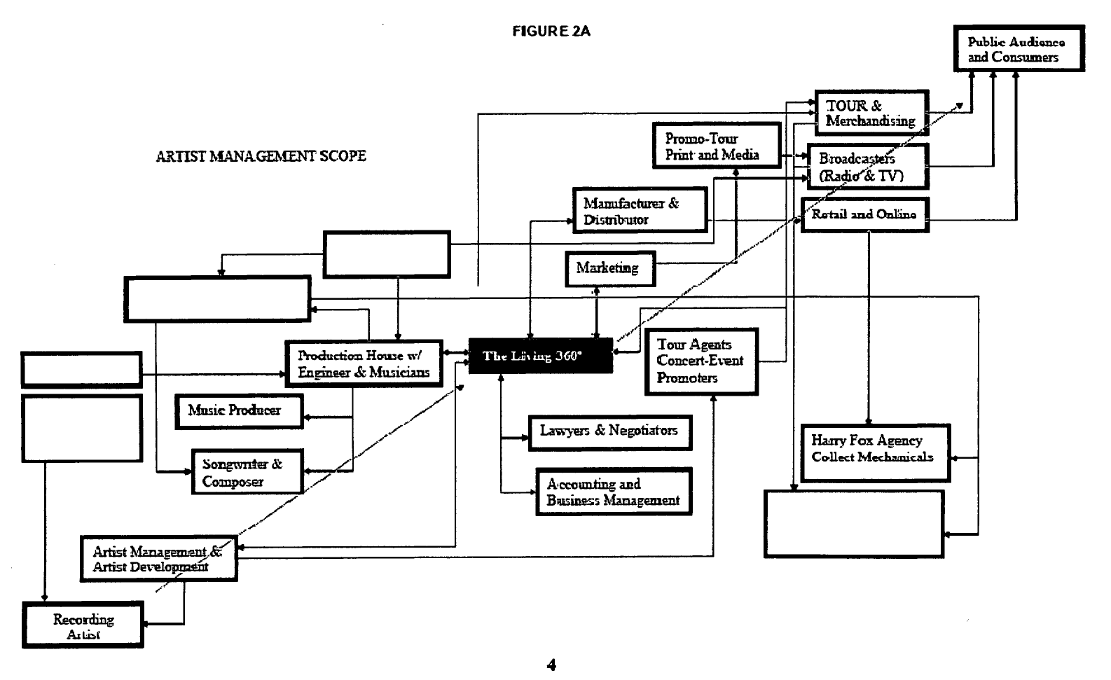

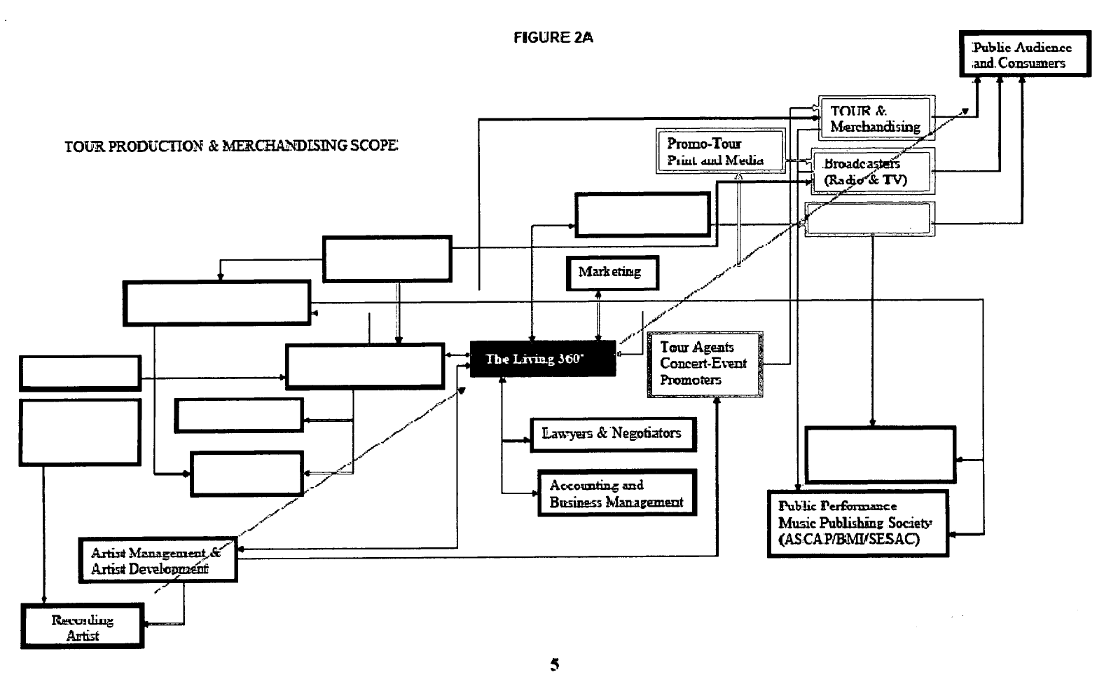

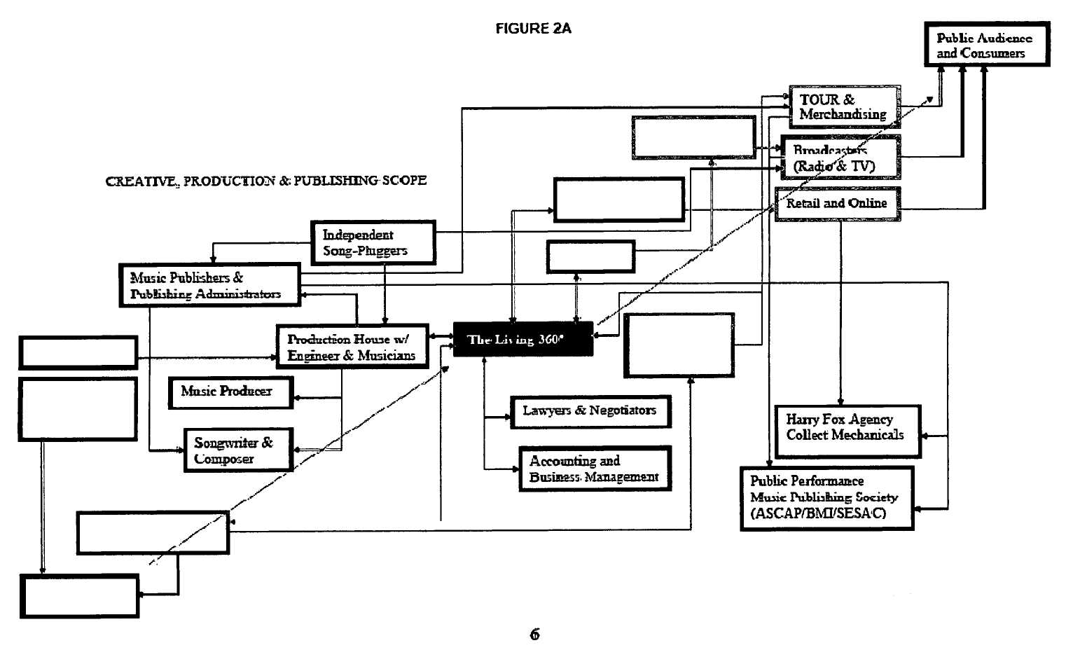

2. We claim: The Development of a Formula which will calculate and standardize the Mechanical Rate; Advertising Agencies and Media departments for Companies, and “other” will pay this rate in exchange for using the Music Content and Format as a Media to market their products and services. The old method is obsolete because it is a “broken system” and cannot generate a fair distribution of wealthy for each vested entity within the music industry. This is a “New and Fair” royalty rates, residuals, and fee formula.
Premise: If music shall become a “media” then a standardize rate for advertisers must be established commensurate with the following considerations:
a) Overall Approximate Audience size in Music Industry
i. According to Nielsen data research there are well over 3 Billion Music enthusiast globally
b) Popularity and Appeal factors related to Music Industry
c) Impact on Sales of Advertised Product or Service by Music Industry Assets
i. Reaching consumers through interactive marketing methods and focusing on “Lifestyle Targeting” marketing methods is the most accurate strategy in predicting consumer behavior. Music is directly associated with Lifestyle and social trends more than any other medium and it's new digital formats make it the user friendly for interactive marketing plans.
d) Scaleable and measurable trend factors regarding Music Industry Assets
e) Accessibility, logistics, format and packaging, and durability and life
i. New digital formats make it the user friendly for transport, instantaneous delivery, master duplication is inexpensive and storage size is at a minimum.
New Mechanical Royalty Formula—SEE FIG. 1A (Pages 1 through 6) attached

3. We claim: Development of an eco-systemic business model that will optimize use of the newly developed method and system for processing and allocating revenues earned in the Music Industry, and royalty/residual revenue formula.
